(19) United States
(12) Patent Application Publication
(10) Pub. No.: US 2008/0215694 A1
(43) Pub. Date: Sep. 4, 2008

(54) System and method for unified messaging service

(76) Inventors: Chung-Min Chen, Taipei (TW); Shan-Hung Wu, Taoyuan (TW); Phone Lin, Taipei (TW)

Correspondence Address: TELCORDIA TECHNOLOGIES, INC., ONE TELCORDIA DRIVE 5G116, PISCATAWAY, NJ, 08854-4157, US

(21) Appl. No.: 12/070,238

(22) Filed: Feb. 14, 2008

Related U.S. Application Data
(60) Provisional application No. 60/901,965, filed on Feb. 16, 2007.

(51) Int. Cl. G06F 15/16

(52) U.S. Cl. 709/206

(57) ABSTRACT

System, method and program storage device for unified messaging services. The method includes receiving a message generated by a sender, collecting user attribute information of the sender and/or a recipient, providing at least one policy factor associated with the user attribute information, converting the first message into a unified format message, processing the user attribute information of the sender and/or the recipient and the policy factor to determine a terminal device for the recipient, converting the unified format message into a second message according to the determined terminal device for the recipient and delivering the message converted according to the determined terminal device for the recipient to the recipient.

### CROSS-REFERENCE TO RELATED APPLICATIONS

This application claims the benefit of U.S. Provisional Application No. 60/901,965, filed on Feb. 16, 2007, by Chung-Min Chen, Shan-Hung Wu, and Phone Lin, to which a claim of priority is hereby made and the disclosure of which is incorporated by reference.

### FIELD OF THE INVENTION

The present application relates broadly to a unified messaging service system and method, and more particularly, to a unified messaging service platform configured for receiving, processing and supplying messages to a recipient, independent of message format and/or the type of terminal devices used by the recipient accessing the messages.

### BACKGROUND OF THE INVENTION

Messaging services have become one of the major applications for people to communicate with each other. With the improvement in network bandwidth and capability of mobile devices, message services are not limited to a notification with pure text. The Multimedia Message Service (MMS) was being developed and standardized to deliver rich communication content, such as images and audio/video clips. The Instant Messaging (IM) service is also proposed to allow users to exchange rich messages instantly.

However, all of the message service environments, such as Short Message Service (SMS), Email, MMS, IM and voice calls, have been developed independently and thus not compatible with each other. Therefore, it is necessary for users to have multiple accounts on different communication devices implementing the above-mentioned different services in order to use these services. Prior to sending messages, a message sender needs to choose a service type to contact the message receiver. Misjudgment of the service type is commonly made, which can delay the time when the messages are actually read. This poses a problem that the users cannot obtain messages anytime and anywhere by means of any available terminal device.

Unified communication systems have been developed as a way of enhancing messaging services. The known techniques providing the Unified Messaging (UM) service can be generally categorized into three types.

The first type of technique is based on smart devices using a single mobile platform. The smart device-based approach simply installs multiple messaging user-agents, for example, a client providing Email communication services, a media network and MMS clients, on a single device to enable an integrated multi-functional device. Since these agents are independent from each other, the smart device-based UM service is available only when each user is equipped with such a multi-functional and usually expensive device. Thus, the above hardware-dependent approach incurs high cost for enabling UM service.

The second type of technique is based on modification of existing protocols. The protocol-based approach modifies existing protocols to achieve the UM service. Such modification may result in compatibility problems with existing protocols or applications, which is normally undesirable and should be avoided. Furthermore, both of the first and second types of techniques are considered costly and not easy to be implemented in the near future.

The third type of technique is based on the adoption of a specialized gateway. The gateway-based approach integrates different messages, such as SMS, MMS, IM and Email, to create a UM platform by performing message conversion through a messaging gateway. However, existing gateway-based approaches do not address the need for developing a suitable message forwarding policy to meet the specific needs of different users. Hence, the users, especially the recipients of the unified message, have not been able to fully utilize the beneficial features of message integration. Further, sub-optimal message conversion and forwarding can easily increase the latency of a message before it is actually read. For example, under the circumstance where a sender sends out an Email to a recipient and at the same time the recipient only has SMS capacities, the message cannot be accessed by the recipient, even though the Email might have been converted to a unified message. This can cause undesirable message delay, since the UM platform enabled by the gateway-based approach is not capable of forwarding the unified message to a recipient, regardless of the messaging capacities of the recipient.

Furthermore, the users of the UM platform may have various requirements or preferences when the messaging services are being implemented. For example, if more than one terminal device is available to the recipient when the sender sends out a message, the recipient may intend to access the message in accordance with preset requirements or preferences. For example, an Email is sent to a recipient who has messaging capacities for Email, IM and SMS, and the recipient may only intend to access the IM or access the IM prior to the Email. Thus, there is a need for the UM platform to interactively determine what types of services are available to the recipient and further what the requirements or preferences of the recipient are. Since the above-mentioned UM platform enabled by the gateway-based approach has failed to develop an intelligent message forwarding policy, an information processing functionality of dynamically determining a suitable message service for each individual recipient and interactively forwarding messages in accordance with the user's requirements or preferences is not available.

Moreover, all the known approaches do not envision an extensible and interactive message forwarding environment, in which third-party application services can be developed based on the UM service.

Therefore, it is desirable and advantageous to provide an arrangement that enables a unified messaging service system to integrate different types of messages into a unified message and further forward the message in a suitable format without requiring the users to be equipped with hardware for all the available messaging services.

It is also desirable and advantageous to provide an arrangement that enables a unified messaging service system to integrate different types of messages into a unified message and further deliver the message to the recipient in a most suitable format without modifying existing communication protocols.

It is also desirable and advantageous to provide an arrangement that enables a unified messaging service system for a unified message recipient to retrieve the message by a user access device independent of the type of the device and the messaging service environments.

It is also desirable and advantageous to provide an arrangement that enables a unified messaging service system to dynamically determine the most suitable messaging service for each individual recipient of messages and interactively forward the messages pursuant to the requirements or preferences of the users.

It is also desirable and advantageous to provide an arrangement that enables a unified messaging service platform to provide an interactive mechanism for facilitating third party service providers to develop third part applications within the unified messaging scheme.

### BRIEF SUMMARY OF THE INVENTION

System, method and program storage device for providing unified messaging services are provided. A method used in a unified messaging system for providing messaging services between at least one message sender and at least one message recipient, both the sender and the recipient having at least one terminal device in communication with the unified messaging system, includes receiving a message generated by the sender, collecting user attribute information of the sender and/or the recipient, providing at least one policy factor associated with the user attribute information, converting the message generated by the sender into a unified format message, processing the user attribute information of the sender and/or the recipient and the policy factor to determine a terminal device for the recipient, converting the unified format message into a message according to the determined terminal device for the recipient, and delivering the message converted according to the determined terminal device for the recipient to the recipient.

A program storage device readable by a machine, tangibly embodying a program of instructions executable by the machine, in one aspect, performs the above described method steps.

A unified messaging system for providing messaging services between at least one message sender and at least one message recipient, both the sender and the recipient having at least one terminal device in communication with the unified messaging system, includes a bearer connection component in communication with different message servers in heterogeneous networks through standard protocols, configured for receiving a message from the sender, sending a message to a recipient and collecting user attribute information of the sender and/or the recipient, and a service mediation component in communication with the bearer connection component, configured for converting the message received by the bearer connection component into a unified format message, retrieving the user attribute information of the sender and/or the recipient collected by the bearer connection component, retrieving at least one policy factor associated with the user attribute information, and processing the user attribute information of the sender and/or the recipient and the policy factor to determine a terminal device for the recipient. The service mediation component further converts the unified format message into a message according to the determined terminal device for the recipient and the bearer connection component delivers the message converted according to the determined terminal device for the recipient to the recipient.

### BRIEF DESCRIPTION OF THE DRAWINGS

These and other features, benefits, and advantages of the present invention will become apparent by reference to the following figures, with like reference numbers referring to like structures across the views, wherein:

FIG. 1 is a block diagram illustrating a unified messaging system according to one exemplary embodiment of the present invention;

FIG. 2 is a diagram illustrating a method used in the unified messaging system according to one exemplary embodiment of the present invention;

FIG. 3 is a diagram illustrating the structure of a unified format message converted by the unified messaging system of FIG. 1 according to one exemplary embodiment of the present invention;

FIG. 4 is a diagram illustrating user attribute information of a sender and/or a recipient using the unified messaging system of FIG. 1 according to one exemplary embodiment of the present invention and a policy factor associated with the user attribute information;

FIG. 5 is a flow chart illustrating an interactive processing resource executable within the unified messaging system of FIG. 1 according to an exemplary embodiment of the present invention, for determining a most suitable terminal device for the recipient by processing the user attribute information and the policy factor; and

FIG. 6 is a diagram illustrating an interactive mechanism of the unified messaging system of FIG. 1 according to one exemplary embodiment of the present invention, wherein an interactive processing flow is enabled among the users of the system and a service extension component of the system.

### DETAILED DESCRIPTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “system”, “component”, “module”, “unit”, “entity” and “mechanism” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

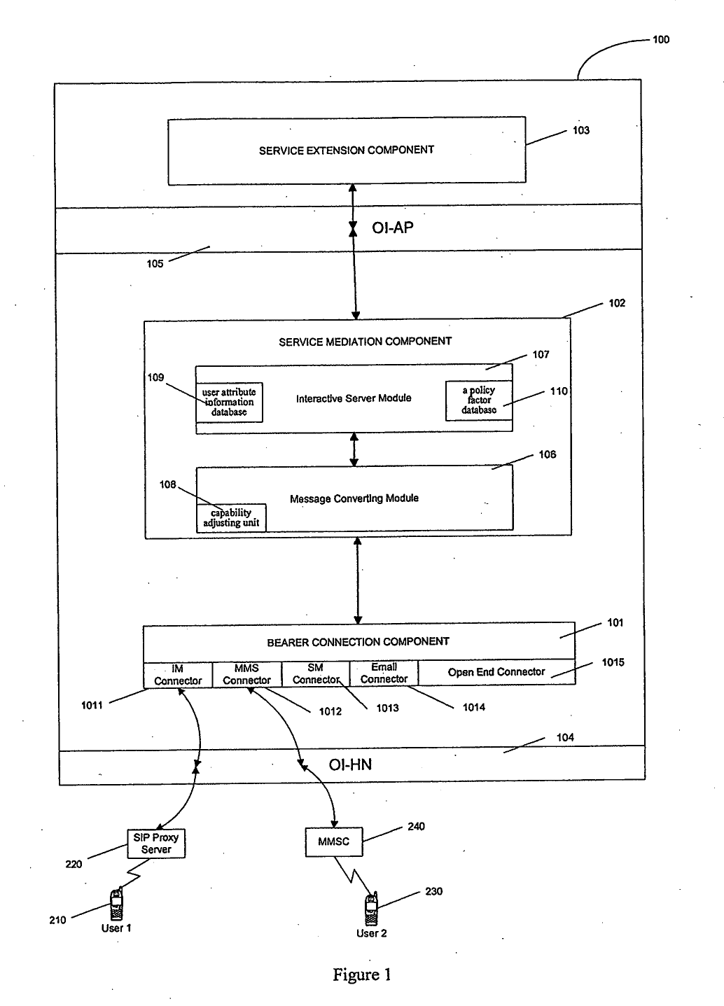

FIG. 1 is a block diagram illustrating an architecture that provides a unified messaging system 100 via heterogeneous networks, according to one exemplary embodiment of the present invention. The unified messaging system 100 functions to provide a messaging service platform between a plurality of users, for example, a message sender and a message recipient having terminal devices in communication with the unified messaging system 100. Specifically, the unified messaging system 100 according to one exemplary embodiment of the present invention is capable of converting messages compatible with different message servers in the heterogeneous networks into a unified format message, determining a suitable terminal device for the recipient of the unified format message, converting the unified format message into a message according to the most suitable terminal device for the recipient and further delivering the message to the recipient. In addition, the unified messaging system 100 also functions to provide a platform for development of value-added application services provided by third-party service providers, and further deliver the unified format message to the recipient of the message based on the application services provided by the service providers.

As shown in FIG. 1, the system 100 generally includes a bearer connection component 101, a service mediation component 102 in communication with the bearer connection component 101 and a service extension component 103 in communication with the service mediation component 102.

The bearer connection component 101 maintains bearer connections between the unified messaging system 100 and the message servers residing in the heterogeneous networks. The bearer connection component 101 is configured for receiving a message from a sender, reporting the message to the service mediation component 102, collecting user attribute information of the sender and/or the recipient and reporting the user attribute information to the service mediation component 102, and further delivering a message to the recipient.

The bearer connection component 101 includes a plurality of connectors, each of which is tailored to be in communication with a message server selected from the different message servers in the heterogeneous networks through standard protocols. The connectors of the bearer connection component 101 function to convert a specific type of message into an object which can be converted by the service mediation component 102 into a unified format message. The connectors connect different message servers, such as Multimedia Message Service Center (MMSC), Session Initiation Protocol (SIP) Proxy Server, Short Message Service Center (SMSC) and Email Server, through standard protocols to enable message transportations between the unified messaging platform and a variety of exiting messaging services. For example, the bearer connection component 101 includes an IM connector 1011, an MMS connector 1012, an SMS connector 1013, an Email connector 1014, and an open-end connector 1015 for any potential message service to be developed in the future.

For example, as illustrated in FIG. 1, a user 210 has a wireless IM device for sending and receiving IM messages relative to a Session Initiation Protocol (SIP) Proxy Server 220, which in turn is in communication with the IM connector 1011 through a standard protocol, such as the SIP IM protocol. In addition, a user 230 has a wireless MMS device for sending and receiving MMS messages relative to an MMSC 240, which in turn is in communication with the MMS connector 1012 through a standard protocol suitable for MMS messages. In the event the user 230 does not have a device capable for receiving an IM message sent from the user 210, the unified messaging system 100 determines a most suitable terminal device, for example, an MMS device, for the user 230, coverts the IM message into MMS messages and delivers the converted MMS message to the user 230 following standard MMS messaging protocol.

Another main functionality of the bearer connection component 101 is forwarding the received messages generated by a sender to the service mediation component 102 for subsequent processing, and collecting user attributes information of the sender and/or a message recipient and reporting the user attribute information to the service mediation component for subsequent processing. The system 100 further includes an Open Interface for Heterogeneous Networks (OI-HN) 104 for accommodating any existing or potential messaging protocols.

The service mediation component 102 of the unified messaging system 100 functions to convert the message received by the bearer connection component 101 into a unified format message, retrieve the user attribute information of the sender and/or the recipient collected by the bearer connection component, retrieve at least one policy factor associated with the user attribute information, and process the user attribute information of the sender and/or the recipient and the policy factor to determine a suitable terminal device for the recipient. Based on the identified terminal device, the service mediation component 102 converts the unified formatted message into a new message compatible with the terminal device and forwards the newly generated message to the bearer connection component 101 for delivering the message to the recipient.

In addition, the service mediation component 102 functions to communicate with the service extension component 103 to enable further application services provided by any third-party service providers. For example, the messages and user attribute information of the sender and/or recipient collected by the bearer connection component 101 can be forwarded through an open interface for applications (OI-AP) 105 to the service extension component 103. Customized application services can be installed on the unified messaging system 100 through the OI-AP 105. The service extension component 103 implements application services, such as a conference call, based on the provided information. The service extension component 103 is able to modify the messages and/or the user attribute information of the sender and/or the recipient. The service extension component 103 is also able to modify the policy factor retrieved by the service mediation component 102 or generate a new policy factor based on the application services provided by extension component 103. Further, the information modified or generated by the service extension component 103 can be fed back to the service mediation component 102 to determine a suitable terminal device for the recipient, and the messages modified by the service extension component 103 are accordingly delivered to the recipient after being converted based on the terminal device for the recipient.

According to the exemplary embodiment of the present invention, the service mediation component 102 includes a message converting module 106 implementing message conversion and message forwarding, and an interactive server module 107 for implementing information processing including but not limited to determining a suitable terminal device for the recipient and communicating with the service extension component 103 for third-party service providers to develop their own application services. In this way, the exemplary embodiment of the present invention provides an advantage that information processing and message forwarding are separated during the entire message processing flow from the sender to the recipient.

The message converting module 106 converts different types of messages compatible with the different message servers in the heterogeneous networks into a unified format message and forwards messages to other functional modules of the unified messaging system 100 for further processing or to the bearer connection component 101 for being delivered to the recipient of the messages through standard protocols. Preferably, the message converting module 106 includes a capability adjusting unit 108 for adjusting the presentation or appearance of messages according to the capabilities of different terminal devices, such as the screen sizes and computing power of the terminal devices. For example, a message sent by a mobile phone having a smaller screen can be adjusted by the capability adjusting module 108 to fit a laptop having a larger screen.

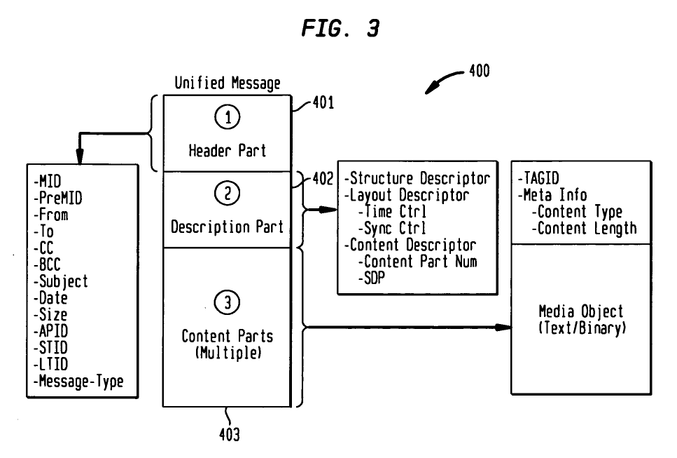

FIG. 3 is a diagram illustrating the structure of a unified format message converted by the message converting module 106. The unified format message, identified by numeral 400, includes a header part 401, a description part 402, and a content part 403. The header part 401 includes a plurality of entries containing but not limited to a message ID (MID), routing information, and subject for the message. The header part 401 further includes information for the service extension component 103 for providing a platform for development of value-added application services, including but not limited to an Application ID (APID), a Session Template ID (STID), a Layout Template ID (LTID) and a preMID. The description part 402 includes, but is not limited to, the timing control and synchronization information to render the message content on the terminal device. Any available description language is allowed in this part, such as Multipurpose Internet Mail Extensions (MIME), Synchronized Multimedia Integration Language (SMIL), and XHTML Mobile Profile (XHTML-MP). The content part 403 includes, but is not limited to, the meta-information and the media objects of the message, which may be text-based or binary-based, for example, images and video/audio clips. Preferably, a unified message may have one or more content parts.

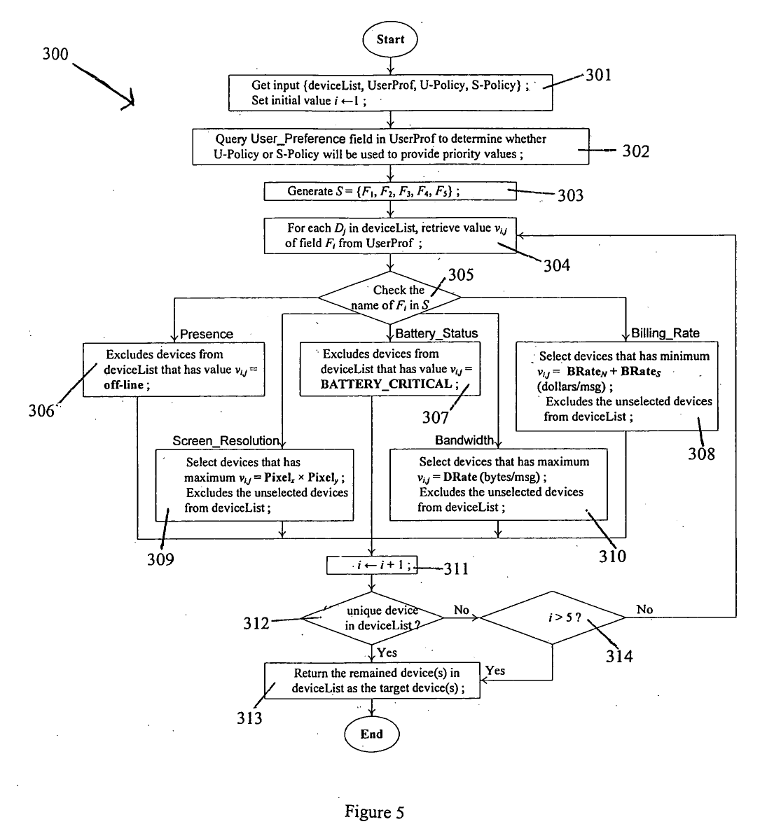

Referring to FIG. 1, the interactive server module 107 functions to dynamically determine a suitable terminal device for the recipient by processing the user attribute information of the sender and/or the recipient collected by the bearer connection component 101 and at least one policy factor associated with the user attribute information retrieved by the interactive server module 107. Specifically, the interactive service module 107 invokes an interactive processing resource executable within the unified messaging system 100 to determine a most suitable terminal device for the recipient based on the user attribute information of the sender and/or the recipient and the policy factor inputted to the resource. Preferably, the interactive processing resource includes a Unified Message Forwarding (UMF) algorithm 300, which will be described in detail with reference to FIG. 5 and which could be invoked to determine a most suitable terminal device for the recipient based on the user attribute information and policy factor inputted into the algorithm.

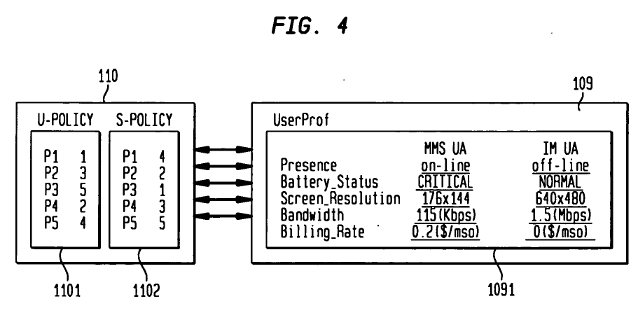

Preferably, the interactive server module 107 includes two functional entities: a user attribute information database 109 for storing the user attribute information of the sender and/or the recipient and a policy factor database 110 for storing at least one policy factor associated with the user attribute information. The two functional entities are now described in reference with FIG. 4, which illustrates the structures and relationship of the two databases. As shown in FIG. 4, the user attribute information database 109 maintains global information of a user in an entity UserProf 1091. The UserProf 1091 stores all the information across heterogeneous networks, including but not limited to account and presence status on each network and terminal capabilities, collected by the bearer connection component 101. The policy factor database 110 stores the at least one policy factor associated with the user attribute information. Preferably, the policy factor can be either generated by users of the unified messaging system 100 or application services provided by the service extension component 103. Preferably, the policy factor database 110 maintains the policy factor provided by the users in an entity U-Policy 1101 and the policy factor provided by the application services in an entity S-Policy 1102.

Preferably, as illustrated in FIG. 4, UserProf 1091 stores user attribute information having a plurality of fields associated with the capability and status of the terminal devices of the sender and/or the recipient, including but not limited to Presence, Battery Status, Screen Resolution, Bandwidth, and Billing Rate of the terminal devices. Preferably, the policy factor database 109 stores a priority policy concerning the priority of the plurality of fields associated with the capability and status of the terminal devices of the sender and/or the recipient. For example, as shown in FIG. 4, the U-Policy 1101 includes five parameters P1-P5 in connection with the above-mentioned five fields respectively and the values of P1-P5 determine the priority of the five fields set by the users of the unified messaging system 100. Similarly, the S-Policy 1102 includes five parameters P1-P5 in connection with the above-mentioned five fields respectively and the values of P1-P5 determine the priority of the five fields set by the application services provided by the service extension component 103. Preferably, the UserProf 109 further includes a field defined as User_Preference, which field can be queried by the UMF algorithm 300 to determine whether the S-Policy and/or the U-Policy would be referenced as the priority of the different fields of the attribute information.

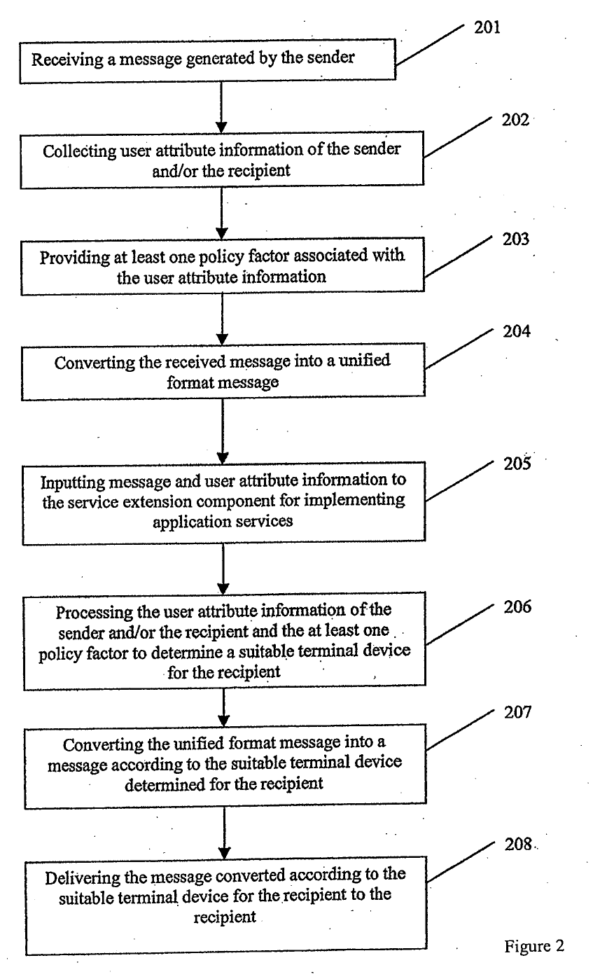

FIG. 2 is a diagram illustrating a method used in the unified messaging system according to one exemplary embodiment of the present invention. The steps of the method according to one exemplary embodiment of the present invention will be described in connection with the functional components and modules of the unified messaging system 100 for providing messaging services between at least one message sender and at least one message recipient, both the sender and the recipient having at least one terminal device in communication with the unified messaging system. Further, the method will be described under the circumstance where the user 210 (sender) sends an IM message to the user 230 (recipient), and where it is determined that a most suitable terminal device for the recipient 230 is a terminal device for MMS messages and preferably application services are implemented by the service extension component 103 before message delivery.

At step 201, a message generated by the sender is received by the unified messaging system 100. Specifically, the sender 210 sends an IM message to the IM connector 1011 of the bearer connection component 101 through the SIP proxy server following the SIP IM protocol. The IM connector 1011 connecting to the SIP proxy server intercepts the IM message and forwards the same to the message converting module 106 of the service mediation component 102.

At step 202, user attribute information of the sender and/or the recipient is collected. Preferably, the user attribute information of the sender and/or the recipient is collected by the bearer connection component 101 and further reported to the service mediation component 102. Preferably, the information is stored in the user attribute information database 109 in the form of the UserProf 1091 having five different fields of user attribute information concerning the capability and status of the terminal devices of the sender and/or the recipient.

At step 203, at least one policy factor associated with the user attribute information is provided. Preferably, the policy factor is stored in the policy factor database 110 of the unified messaging system 100 and retrievable by the interactive server module 107 of the service mediation component 102. Preferably, the policy factor includes a priority policy of the fields of user attribute information concerning the capability and status of the sender and/or the recipient. More preferably, the priority policy includes a U-Policy 1101 provided by the user and/or an S-Policy provided by application services enabled by the service extension component 103.

At step 204, the message generated by the sender and received by the system 100 through the bearer connection component 101 is converted into a unified format message, such as the message 400 illustrated in FIG. 3, by the message converting module 106. Preferably, the header part 401 of the unified format message 400 is further passed to the interactive server module 107 for invoking application services through the service extension component 103.

Preferably, at step 205, the unified format message 400 and the collected user attribute information of the sender and/or the recipient, such as UserProf 1109 stored in the user attribute information database 109, are inputted to the service extension component 103 of the unified messaging system for implementing application services. Specifically, if it is determined at this step that an application ID (APID) is defined in the header part 401 of the message 400, the interactive server module 107 passes the UserProf 1109 and the header part 401 of the message 400 to the service extension component 10, for triggering either an in-band or out-band service depending on the service logic subscribed.

For example, the service extension component 103 may implement a news-broadcasting application including more than one recipient of the message 400. In this case, the interactive server module 107 determines a suitable terminal device for each recipient, and messages are delivered to each recipient in a format compatible with the suitable terminal device of each recipient. Other application services are also available to the unified format message, based on which the interactive server module 107 determines a most suitable terminal device for the recipients. Preferably, the message 400 and the UserProf 1109 are modified by the service extension component 103 depending on the application services provided by the service extension component 103.

At step 206, the user attribute information of the sender and/or the recipient and the at least one policy factor are processed to determine a suitable terminal device for the recipient. Preferably, at this step, the interactive server module 107 invokes an interactive processing resource executable within the unified messaging system 100 to determine a most suitable terminal device for the recipient based on the user attribute information of the sender and/or the recipient and the policy factor inputted to the resource. Preferably, the interactive processing resource includes a Unified Message Forwarding (UMF) algorithm 300. Specifically, the UserProf 1091 stored in the user attribute information database 109 and the U-Policy 1101 and/or the S-Policy 1102 stored in the policy factor database 110 are retrieved and inputted into the algorithm 300.

Preferably, the UserProf 1091 contains different fields of attribute information associated with the status and capability of the terminal devices of the users including but not limited to Presence, Battery Status, Screen Resolution, Bandwidth and Billing Rate, and the U-Policy 1101 and/or the S-Policy 1102 indicates the priority of the fields determined by the users and the application services, respectively. The user attribute information and the policy factor, and preferably other information concerning the properties of the terminal devices, are inputted to the algorithm 300 for executing the step of determining a most suitable terminal device for the recipient. For example, it is determined at this step that the most suitable terminal device for the recipient to receive the IM message generated at step 201 is a terminal device for MMS messages.

At step 207, the unified format message 400 is converted into a message according to the suitable terminal device determined for the recipient. Specifically, at this step, the interactive server module 107 modified the message header 401 of the unified format message 400 based on the decision made in step 206, and the modified header indicating the most suitable terminal device for each recipient is forwarded to the message converting module 106. Subsequently, the message converting module 106 converts the unified format message 400 into a new message compatible with the determined terminal device for the recipient and forwards it to a new connector in the bearer connection component 101. For example, since it is determined at step 206 that a suitable terminal device for the recipient to receive the IM message generated at step 201 is a terminal device for MMS messages, the message converting module 107 converts the unified format message into an MMS message.

At step 208, the message converted according to the suitable terminal device for the recipient is delivered to the recipient of the message. Specifically, the converted message is forwarded to a suitable connector in the bearer connection component 101 and further delivered to the recipient following a standard protocol. For example, the converted MMS message is forwarded to the MMS connector 1012 of the bearer connection component 101 and further delivered to the recipient 230 following standard protocols.

FIG. 5 is a flow chart illustrating an interactive processing resource executable within the unified messaging system of FIG. 1 according to an exemplary embodiment of the present invention. Preferably, the interactive processing resource includes the Unified Message Forwarding (UMF) algorithm 300.

The UMF algorithm 300 determines a target terminal device for the message recipient by processing the user attribute information and the at least one policy factor. For example, the inputs of the UMF algorithm 300 include a deviceList (terminal IDs), UserProf 1091 containing fields of user attribute information associated with the status and capability of the terminal devices, and the U-Policy 1101 and/or S-Policy 1102 indicating the priority of the fields of the attribute information. As an exemplary embodiment, the UserProf 1091 includes five fields of user attribute information to be processed: Presence of the terminal devices, Battery Status, Screen Resolution, Bandwidth and Billing Rate.

As shown in FIG. 3, at step 301, the UMF algorithm 300 obtains inputs and initializes a counter i to 1. This counter is used for a “for” loop. At step 302, the UMF algorithm 300 queries a User_Preference field (shown in FIG. 4) in the UserProf 1091 to determine whether the S-Policy 1101 and/or U-Policy 1102 will be referenced for the priority of these five fields. At step 303, the UMF algorithm 300 sorts the fields according to the priority values obtained in step 302 and generates a set S={F1, F2, F3, F4, F5}, where Fᵢ indicates a field. At step 304, for each device Dⱼ indicated in the deviceList, the UMF algorithm 300 retrieves the field value corresponding to Fᵢ from the UserProf 1091. This value is denoted as v_{i,j}. At step 305, one of the following five events described in steps 306-310 is executed according to Fᵢ.

At step 306, the value of the field Presence is evaluated and the terminal devices that appear to be off-line are excluded. At step 307, the value of the field Battery Status is evaluated and the devices having critical battery power are excluded. At step 308, the value of the field Billing Rate is evaluated to select terminal devices that are able to run messaging with a minimal billing rate and to exclude unselected devices from the deviceList. At this step, at least two kinds of rates are considered, i.e., billing rate in the barrier network (BRateN) and billing rate of the application services (BRateS). At step 309, the value of the field Screen Resolution is evaluated to select terminal devices that have maximum screen resolution and to exclude the unselected devices from the deviceList. At step 310, the value of the field Bandwidth is evaluated, to select terminal devices that have maximum transmission rate (DRate) and to exclude the unselected devices from the deviceList.

At step 311, the UMF algorithm 300 increases i for the next loop. At step 312, it is determined whether there is only one terminal device in the deviceList. If that is the case, at step 313, the terminal device is selected as the target device, and the UMF algorithm 300 ends. Otherwise, if there are more than one qualified terminal devices in the deviceList, then the UMF algorithm 300 runs the next loop. At step 314, it is further determined whether all the five fields have been evaluated. If that is the case, the remaining device(s) in the deviceList is returned as the target terminal device(s), and the UMF algorithm ends. Preferably, the target terminal service can be determined as the one, which is available to the recipient and has the highest priority.

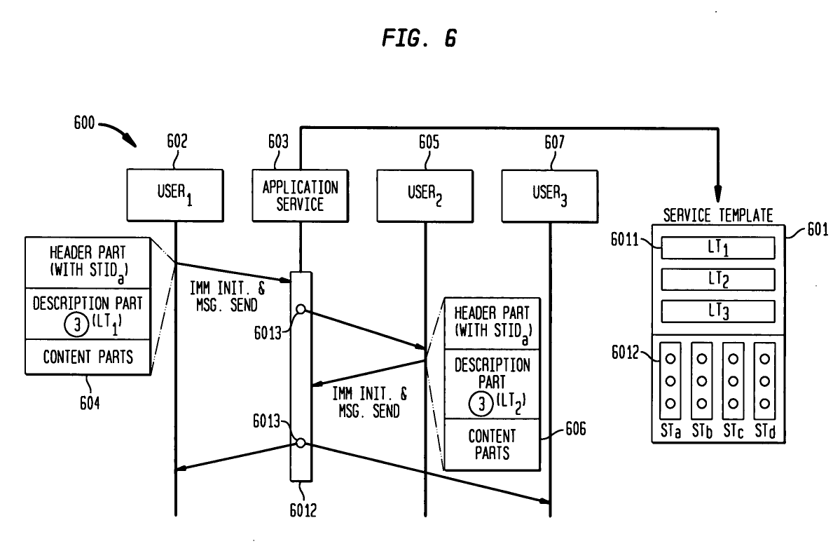

FIG. 6 is a diagram illustrating an interactive messaging mechanism 600 of the unified messaging system of FIG. 1 according to one exemplary embodiment of the present invention, wherein an interactive processing flow is enabled among the users of the system and the service extension component of the system for facilitating a third-party service provider to provide application services. To facilitate application provisioning, a series of message exchanges associated with an action or a function offered by the service provider are executed, which is defined as a session. As shown in FIG. 6, the interactive messaging mechanism 600 includes a service template 601 defined by each application service, which consists of a plurality of Layout Templates (LTs) 6011 and a plurality of Session Templates (STs) 6012.

Each of the LTs 6011 provides a predefined description part of a message and enables convenient message establishment since there is no need for the users to edit format of the messages. Each of the STs 6012 predefines at least one service trigger point 6013. The service trigger point 6013 specifies the necessary operations, such as inviting users, filtering messages and so on, that should be executed at a particular session stage. The following is a description of how an application service is implemented based on the interactive messaging mechanism 600.

If a user 602 intends to trigger an action offered by an application service 603, the user 602 sends an initialization request to the application server 603 to get the service template of the server. The user 602 can select an ST identified by STIDa, and an LT in the service template, to create a message 604. The IDs of the application service and the chosen templates are set into the header part of the message 604 as Application ID (APID), Session Template ID (STID), and Layout Template ID (LTID), respectively. The message ID (MID) can be filled by any random number. The application server 602 is able to intercept the message by means of the APID in the header part of the message whenever the message is processed by the unified messaging system.

If a user 605 replies by generating a reply message 606 having its STID set as the STIDa and its preMID set as the MID of the message 604 sent by user 602, the application server 603, upon intercepting this reply message, is able to correctly find the session the reply message belongs to through the STID and determine the session stage through preMID. Therefore, corresponding operations, such as, inviting a user 607 to join the session, can be triggered.

According to one exemplary embodiment of the invention, one major advantage achieved is that the unified messaging system separates information processing implemented by the interactive module 107 from messaging forwarding implemented by the message converting module 106 during the entire message processing flow. In addition to message conversion and integration, the system adopts an interactive processing resource, such as a Unified Message Forwarding (UMF) algorithm, to dynamically select the most suitable target terminal device as well as messaging service for the recipient. Furthermore, service extensions for implementing application services provided by third-party service providers are also available by a service extension part adapting an interactive messaging mechanism.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for providing unified messaging services between at least one message sender and at least one message recipient, both the sender and the recipient having at least one terminal device in communication with a unified messaging system, comprising:
receiving a message generated by the sender;
collecting user attribute information of the sender and/or the recipient;
providing at least one policy factor associated with the user attribute information;
converting the message generated by the sender into a unified format message;
processing the user attribute information of the sender and/or the recipient and the policy factor to determine a terminal device for the recipient;
converting the unified format message into a message according to the determined terminal device for the recipient; and
delivering the message converted according to the determined terminal device for the recipient to the recipient.

2. The method of claim 1, wherein processing the user attribute information of the sender and/or the recipient and the policy factor to determine a terminal device for the recipient comprises invoking an interactive processing resource executable within the unified system to determine a most suitable terminal device for the recipient based on the user attribute information of the sender and/or the recipient and the policy factor inputted to the resource.

3. The method of claim 1, wherein the user attribute information of the sender and/or the recipient comprises a plurality of fields of user attribute information associated with the capability and status of the terminal devices of the sender and/or the recipient, and the at least one policy factor associated with the user attribute information comprises a priority policy of the fields.

4. The method of claim 1, wherein collecting user attribute information of the sender and/or the recipient comprises collecting user attribute information of the sender and/or the recipient through a bearer connection component in communication with message servers in heterogeneous networks through a standard protocol and storing the user attribute information in a user attribute information database disposed within the unified messaging system.

5. The method of claim 1, wherein providing at least one policy factor comprises accessing a policy factor database disposed within the unified messaging system for storing the policy factor to retrieve the at least one policy factor.

6. The method of claim 1, further comprising determining the capability of the determined terminal device for the recipient and adjusting the presentation of the message converted according to the determined terminal device for the recipient according to the capability of the determined terminal device for the recipient.

7. The method of claim 1, further comprising inputting the unified format message and the collected user attribute information of the sender and/or the recipient to at least one service extension component of the unified messaging system for implementing application services to the unified format message.

8. The method of claim 7, wherein implementing application services to the unified format message comprises invoking an interactive messaging mechanism for facilitating application services provisioning.

9. The method of claim 7, further comprising modifying the unified format message and the collected user attribute information of the sender and/or the recipient by the service extension component.

10. The method of claim 9, wherein processing the user attribute information of the sender and/or the recipient wherein, and the policy factor to determine a terminal device for the recipient comprises processing the modified user attribute information of the sender and/or the recipient and the policy factor to determine a terminal device for the recipient and converting the unified format message into a message according to the determined terminal device for the recipient comprises converting the modified unified format message into a second message according to the determined terminal device for the recipient.

11. The method of claim 7, wherein the service extension component for providing application services comprises a service extension component for providing an application service defining one or more message recipients of the unified format message.

12. The method of claim 11, further comprising modifying the unified format message and the collected user attribute information of the sender and/or the recipients by the service extension component.

13. The method of claim 12, wherein processing the user attribute information of the sender and/or the recipient and the policy factor to determine a terminal device for the recipient comprises processing the modified user attribute information of the sender and/or the recipients and the policy factor to determine a terminal device for each recipient respectively defined by the application service provided by the service extension component.

14. The method of claim 13, wherein converting the unified format message into a message according to the determined terminal device for the recipient and forwarding the message converted according to the determined terminal device for the recipient to the recipient comprises converting the modified unified format message into a message according to the determined terminal device for each recipient respectively defined by the application service provided through the service extension component and forwarding said converted message according to the determined terminal device for each recipient to said each recipient respectively.

15. A unified messaging system for providing messaging services between at least one message sender and at least one message recipient, both the sender and the recipient having at least one terminal device in communication with the unified messaging system, comprising:
a bearer connection component in communication with different message servers in heterogeneous networks through standard protocols, configured for receiving a message from the sender, sending a message to a recipient and collecting user attribute information of the sender and/or the recipient;
a service mediation component in communication with the bearer connection component, configured for converting the message received by the bearer connection component into a unified format message, retrieving the user attribute information of the sender and/or the recipient collected by the bearer connection component, retrieving at least one policy factor associated with the user attribute information, and processing the user attribute information of the sender and/or the recipient and the policy factor to determine a terminal device for the recipient,
wherein the service mediation component further converts the unified format message into a message according to the determined terminal device for the recipient and the bearer connection component delivers the message converted according to the determined terminal device for the recipient to the recipient.

16. The system of claim 15, wherein the bearer connection component comprises a plurality of connectors in communication respectively with the different message servers in heterogeneous networks through standard protocols.

17. The system of claim 15, further comprising an open interface for heterogeneous networks for communicationally connecting the bearer connection component to the service mediation component.

18. The system of claim 15, wherein the service mediation component comprises a message converting module for converting different messages compatible with the different message servers in heterogeneous networks into a unified format message.

19. The system of claim 18, wherein the message converting module comprises a capability adjusting unit for adjusting the presentation of messages according to capabilities of the determined terminal device for the recipient.

20. The system of claim 15, wherein the service mediation component comprises an interactive server module for invoking an interactive processing resource executable within the unified messaging system to determine a most suitable terminal device for the recipient based on the user attribute information of the sender and/or the recipient and the policy factor inputted to the resource.

21. The system of claim 20, wherein the interactive server module comprises a policy factor database for storing the at least one policy factor associated with the user attribute information of the sender and/or the recipient.

22. The system of claim 20, wherein the interactive server module comprises a user attribute information database for storing the user attribute information of the sender and the server collected by the bearer connection component.

23. The system of claim 15, wherein the user attribute information of the sender and/or the recipient collected by the bearer connection component comprises a plurality of fields of user attribute information associated with the capability and status of the terminal devices of the sender and/or the recipient, and the at least one policy factor associated with the user attribute information comprises a priority policy of said fields.

24. The system of claim 23, wherein the service mediation component comprises an interactive server module for invoking an interactive processing resource executable within the unified messaging system to determine a terminal device for the recipient based on a plurality of fields of user attribute information associated with the capability and status of the terminal devices of the sender and/or the recipient and the priority policy of the fields inputted to the resource.

25. The system of claim 15, further comprising a service extension component in communication with service mediation component for providing application services.

26. The system of claim 25, further an open interface for applications for communicationally connecting the service extension component with the service mediation component.

27. The system of claim 25, wherein the service extension component modifies the unified format message and the user attribute information of the sender and/or the recipient to generate a modified unified format message and modified user attribute information of the sender and/or the recipient.

28. The system of claim 26, wherein the service mediation component comprises an interactive server module for invoking an interactive processing resource executable within the unified messaging system to determine a most suitable terminal device for the recipient based on the modified user attribute information of the sender and/or the recipient and the policy factor inputted to the resource.

29. The system of claim 28, wherein the service mediation component converts the modified unified format message into a message according to the most suitable terminal device for the recipient and the bearer connection component forwards the message converted according to the most suitable terminal device for the recipient to the recipient.

30. The system of claim 25, wherein the service extension component for providing message application services comprises a service extension component for providing an application service defining one or more message recipients of the unified format message.

31. The system of claim 30, wherein the service extension component modifies the unified format message and the collected user attribute information of the sender and/or the recipients to generate a modified unified format message and modified user attribute information of the sender and/or the recipients.

32. The system of claim 31, wherein the service mediation component comprises an interactive server module for invoking an interactive processing resource executable within the unified messaging system to determine a most suitable terminal device for each recipient based on the modified user attribute information of the sender and/or the recipient and the policy factor inputted to the resource.

33. The system of claim 32, wherein the service mediation component converts the modified unified format message into a message according to the most suitable terminal device for each recipient and the bearer connection component forwards the message converted according to the most suitable terminal device for each recipient to each recipient respectively.

34. A program storage device readable by machine, tangibly embodying a program of instructions executable by the machine to perform a method used in a unified messaging system for providing messaging services between at least one message sender and at least one message recipient, both the sender and the recipient having at least one terminal device in communication with the unified messaging system, comprising:
receiving a message generated by the sender;
collecting user attribute information of the sender and/or the recipient;
providing at least one policy factor associated with the user attribute information;
converting the first message into a unified format message;
processing the user attribute information of the sender and/or the recipient and the policy factor to determine a terminal device for the recipient;
converting the unified format message into a second message according to the determined terminal device for the recipient; and
delivering the message converted according to the determined terminal device for the recipient to the recipient.
